(19) United States
(12) Patent Application Publication
(10) Pub. No.: US 2025/0005337 A1
(43) Pub. Date: Jan. 2, 2025

(54) World-Model-Based Neural-Network Cognition

(71) Applicant: XEG Ventures LLC, Wilmington, DE (US)

(72) Inventor: Kilton Patrick Hopkins, Berkeley, CA (US)

(73) Assignee: XEG Ventures LLC, Wilmington, DE (US)

(21) Appl. No.: 18/751,253

(22) Filed: Jun. 23, 2024

Related U.S. Application Data
(60) Provisional application No. 63/532,894, filed on Aug. 15, 2023.
(60) Provisional application No. 63/523,894, filed on Jun. 28, 2023.

(51) Int. Cl. G06N 3/0475; G06N 3/045; G06N 3/08

(52) U.S. Cl. CPC G06N 3/0475; G06N 3/045; G06N 3/08

(57) ABSTRACT

During operation, a computer system may receive a sequence of sensory inputs (e.g., at different timestamps) associated with an object in an environment. Then, the computer system may train a predictive model that predicts a future location of at least a representation corresponding to the object in the environment based at least in part on the sequence of sensory inputs. Moreover, the computer system may provide a world view of the object in the environment based at least in part on the pretrained predictive model. Note that providing of the world view may include: comparing the predicted future location of at least the representation with the future location of the object in the environment; and when a difference between the predicted future location of at least the representation and the future location of the object in the environment exceeds a predefined value, selectively performing a remedial action.

### CROSS REFERENCE TO RELATED APPLICATIONS

This application claims priority under 35 U.S.C. 119(e) to U.S. Provisional Application Ser. No. 63/532,894, entitled “World-Model-Based Neural-Network Cognition,” by Kilton Patrick Hopkins, filed on Aug. 15, 2023, and to U.S. Provisional Application Ser. No. 63/523,894, entitled “World-Model-Based Neural-Network Cognition,” by Kilton Patrick Hopkins, filed on Jun. 28, 2023, the contents of both of which are herein incorporated by reference.

### FIELD

The described embodiments relate to neural networks. Notably, the described embodiments relate to cognitive features in a neural network based at least in part on a world model that includes a world view of an object in an environment.

### BACKGROUND

Recent developments have significantly improved the performance of artificial neural networks (which are sometimes referred to as ‘neural networks’) is applications such as computer vision. Typically, computer vision in existing neural networks is single-shot or one-shot. Notably, outputs from these existing neural networks are usually based on a single input frame or image.

However, the use of a single frame or image often constrains the performance of existing neural networks. Consequently, existing neural networks have not been able to achieve more sophisticated understanding of input data associated with an environment. For example, true computer perception would entail capabilities such as: elements of cognition (or precursors of cognition); contextual or environmental awareness; and a notion of chronology (or a perception of events as a function of time).

While true computer perception may involve asynchronous searching of memory, in principle computer perception may be approximated using augmentation or suppression of connections between synapses (which are sometimes referred to as ‘nodes’ or ‘neurons’) in a neural network. For example, as illustrated in FIG. 1, a neural network may include synapses that apply weights and combine information associated with features in inputs to a base layer in a hierarchical arrangement of layers. The resulting output at an apex of the hierarchy may represent or correspond to a thing, such as a horse with a confidence interval of 88%. Augmentation or suppression may enhance or suppress this confidence interval by adjusting the weights at one or more of the synapses in the neural network based at least in part on another thing, such as the presence of a rider on the horse.

Note that the ‘knowledge’ in this regard is stored in the neural network, as opposed to memory. If the resulting confidence interval at the apex has sufficient certainty (e.g., the presence of a rider may increase the likelihood that the thing is, in fact, a horse), it may result in a cascade that reinforces the prior paths in the neural network (and, thus, provides context).

Similarly, a synapse in a neural network may provide a stream of outputs as a function of time when activated. Chronology, which may involve the synchronization of multiple pieces of information and perception of events as a function of time, may in principle be approximated using augmentation or suppression.

However, in practice, it is often difficult to implement augmentation or suppression in a neural network. For example, if cross-contextual information (such as the combination of a thing and another thing) is used during training of a neural network, the training dataset (and, thus, the training time, cost, complexity and power consumption) will increase exponentially. These challenges are usually prohibitive. Alternatively, attempts at addressing these challenges by changing the architecture of existing neural networks is also problematic, because the recent developments that have resulted in the aforementioned significant advances are based in part on leveraging or building on standard tools (such as existing neural network architectures) and training datasets.

### SUMMARY

In a first group of embodiments, a computer system (which may include one or more computers) that trains a neural network is described. This computer system includes: a computation device; and memory that stores program instructions. When executed by the computation device, the program instructions cause the computer system to perform one or more operations. Notably, during operation of the computer system, the computer system trains the neural network using a training dataset having content, where at least a subset of the content includes intentionally added predefined bias, and where the intentionally added predefined bias modulates an output of the neural network.

Note that the modulated output may correspond to activation or suppression of one or more synapses in the neural network. For example, the activation or suppression may adjust weights associated with the one or more synapses for a predefined time interval.

Moreover, the intentionally added predefined bias may include additional content that leverages associated learning with one or more features in at least the subset of the content and that are different from the additional content.

Furthermore, the computer system may obtain the content. For example, obtaining the content may include: accessing the content in memory; receiving the content from an electronic device; and/or generating the content. In some embodiments, generating the content may include: adding the intentionally added predefined bias to at least the subset of the content; and/or selecting the intentionally added predefined bias based at least in part on at least the subset of the content.

Another embodiment provides a computer for use, e.g., in the computer system.

Another embodiment provides a computer-readable storage medium for use with the computer or the computer system. When executed by the computer or the computer system, this computer-readable storage medium causes the computer or the computer system to perform at least some of the aforementioned operations.

Another embodiment provides a method, which may be performed by the computer or the computer system. This method includes at least some of the aforementioned operations.

In a second group of embodiments, a computer system (which may include one or more computers) that receives a modified output is described. This computer system includes: a computation device; and memory that stores program instructions. When executed by the computation device, the program instructions cause the computer system to perform one or more operations. Notably, during operation of the computer system, the computer system implements a pretrained neural network. Then, the computer system selectively provides, to the pretrained neural network, input content that includes intentionally added predefined bias. In response, the computer system receives, from the pretrained neural network, the modified output relative to an output of the pretrained neural network when the content is provided to the pretrained neural network without the intentionally added predefined bias.

Note that the modified output may correspond to activation or suppression of one or more synapses in the neural network. For example, the activation or suppression may adjust weights associated with the one or more synapses for a predefined time interval.

Moreover, the intentionally added predefined bias may include additional content that leverages associated learning with one or more features in the content and that are different from the additional content.

Furthermore, the intentionally added predefined bias may provide a program interference to query the pretrained neural network. For example, the query may assess bias that is inherent to the pretrained neural network.

Alternatively or additionally, the query may assess relationships or associations within the pretrained neural network. For example, the relationships or associations may include: one or more interconnections between a pair of synapses in the pretrained neural network; one or more interconnections between groups of synapses in the pretrained neural network; one or more interconnections between layers in the pretrained neural network; and/or temporal or spatial relationships associated with the pretrained neural network.

In some embodiments, the intentionally added predefined bias may, at least in part, correct for the bias that is inherent to the pretrained neural network.

Another embodiment provides a computer for use, e.g., in the computer system.

Another embodiment provides an electronic device that performs the operations of the computer system.

Another embodiment provides a computer-readable storage medium for use with the computer, the electronic device or the computer system. When executed by the computer, the electronic device or the computer system, this computer-readable storage medium causes the computer, the electronic device or the computer system to perform at least some of the aforementioned operations.

Another embodiment provides a method, which may be performed by the computer or the computer system. This method includes at least some of the aforementioned operations.

In a third group of embodiments, a computer system (which may include one or more computers) that facilitates neural-network cognitive features based at least in part on a world model that includes a world view of an object in an environment is described. This computer system includes: a computation device; and memory that stores program instructions. When executed by the computation device, the program instructions cause the computer system to perform one or more operations. During operation, the computer system receives a sequence of sensory inputs associated with the object in the environment, where the sequence of sensory inputs occurs at different timestamps. Then, the computer system trains a predictive model that predicts a future location of at least a representation corresponding to the object in the environment based at least in part on the sequence of sensory inputs. Moreover, the computer system provides the world view of the object in the environment based at least in part on the pretrained predictive model. Note that providing of the world view includes: comparing the predicted future location of at least the representation with the future location of the object in the environment; and when a difference between the predicted future location of at least the representation and the future location of the object in the environment exceeds a predefined value (such as 0.1, 1, 3, 5 or 10%), selectively performing a remedial action.

Moreover, the sequence of sensory inputs may include images. However, in general, the sensory inputs may include or may be associated with images, sound, text, etc.

Furthermore, the representation may include a three-dimensional (3D) bounding box surrounding the object. For example, the representation may include a geometric object specified by at least four vertices. In some embodiments, the geometric object may be specified by an orientation. Note that the geometric object may be specified by metadata that includes one or more labels for the object or one or more classifications of the object.

Additionally, the predictive model may be generated using a generative neural network transformer.

In some embodiments, the operations may include operating, based at least in part on the pretrained predictive model and relative to operation without the pretrained predictive model, an electronic device (such as one or more image sensors or a computer) that acquires the sensory inputs at one or more of: at reduced power consumption, a reduced acquisition rate of the sensory inputs, a reduced latency of the sensory inputs, an increased accuracy of the sensory inputs, or identification of motion of the object even when a classification of the object is unknown.

Note that the operations may include reducing, based at least in part on the pretrained predictive model and relative to operation without the pretrained predictive model, a size of a training dataset used to train the pretrained predictive model.

Moreover, the operations may include storing, in memory, the pretrained predictive model.

Furthermore, the remedial action may include switching from the pretrained predictive model to a second pretrained predictive model, and the second pretrained predictive model may more accurately predict the future location of the object than the pretrained predictive model. In some embodiments, the operations may include concurrently executing the pretrained predictive model and the second pretrained predictive model. For example, the pretrained predictive model and the second pretrained predictive model may be concurrently executed when the predictive performances of the pretrained predictive model and the second pretrained predictive model are less than a predefined value (such as 90, 95 or 99%). In some embodiments, the remedial action may include augmenting or suppressing the second pretrained predictive model based at least in part on the difference.

Additionally, the remedial action may include concurrently executing multiple pretrained predictive models based at least in part on the difference and the multiple pretrained predictive models may be different from the pretrained predictive model.

Note that the sensory information may include multiple different perspectives of the object.

Moreover, the operations may include providing learning addressed to a second computer system or receiving second learning associated with the second computer system. The learning or the second learning may include information associated with the pretrained predictive model or the second pretrained predictive model.

Furthermore, the remedial action may include: changing values of weights in the pretrained predictive model, augmenting at least a portion of the pretrained predictive model, and/or suppressing at least a second portion of the pretrained predictive model.

Additionally, the operations may include providing the world view to a pretrained neural network.

Note that the environment may include a physical environment or a virtual environment. For example, the virtual environment may include a feature space associated with one or more search queries. Consequently, the sequency of sensory inputs may include a sequence of search queries provided to the computer system.

Another embodiment provides a computer for use, e.g., in the computer system.

Another embodiment provides an electronic device that performs the operations of the computer system.

Another embodiment provides a computer-readable storage medium for use with the computer, the electronic device or the computer system. When executed by the computer, the electronic device or the computer system, this computer-readable storage medium causes the computer, the electronic device or the computer system to perform at least some of the aforementioned operations.

Another embodiment provides a method, which may be performed by the computer or the computer system. This method includes at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a drawing illustrating an example of a portion of neural network.

FIG. 2 is a block diagram illustrating an example of a computer system in accordance with an embodiment of the present disclosure.

FIG. 3 is a flow diagram illustrating an example of a method for training a neural network using a computer system in FIG. 2 in accordance with an embodiment of the present disclosure.

FIG. 4 is a drawing illustrating an example of communication between components in a computer system in FIG. 2 in accordance with an embodiment of the present disclosure.

FIG. 5 is a flow diagram illustrating an example of a method for receiving a modified output from a pretrained neural network using a computer system in FIG. 2 in accordance with an embodiment of the present disclosure.

FIG. 6 is a drawing illustrating an example of communication between components in a computer system in FIG. 2 in accordance with an embodiment of the present disclosure.

FIG. 7A is a drawing illustrating an example of content without intentionally added predefined bias in accordance with an embodiment of the present disclosure.

FIG. 7B is a drawing illustrating an example of content with intentionally added predefined bias in accordance with an embodiment of the present disclosure.

FIG. 8 is a flow diagram illustrating a method for providing a world view of an object in an environment using a computer system in FIG. 2 in accordance with an embodiment of the present disclosure.

FIG. 9 is a block diagram illustrating an example of a neural network in accordance with an embodiment of the present disclosure.

FIG. 10 is a block diagram illustrating an example of operations performed by blocks in a neural network in accordance with an embodiment of the present disclosure.

FIG. 11 is a block diagram illustrating an example of a computer system in accordance with an embodiment of the present disclosure.

FIG. 12 is a block diagram illustrating an example of a computer in a computer system in FIG. 2 or 11 in accordance with an embodiment of the present disclosure.

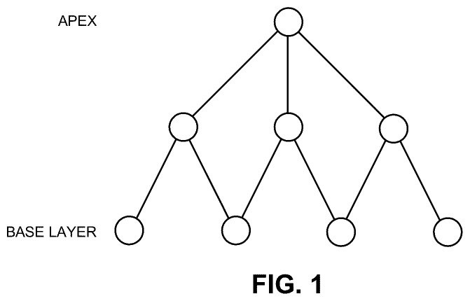

Note that like reference numerals refer to corresponding parts throughout the drawings. Moreover, multiple instances of the same part are designated by a common prefix separated from an instance number by a dash.

### DETAILED DESCRIPTION

In a first group of embodiments, a computer system (which may include one or more computers) that trains a neural network is described. During operation, the computer system may obtain content. Then, the computer system may train the neural network using a training dataset having content, where at least a subset of the content includes intentionally added predefined bias, and where the intentionally added predefined bias modulates an output of the neural network. Note that the modulated output may correspond to activation or suppression of one or more synapses in the neural network. For example, the activation or suppression may adjust weights associated with the one or more synapses for a predefined time interval (such as a duration of the presence of contextual information or an environmental condition in a frame, or a duration of a frame, and thus is different from updating the numerical weights associated with synapses during training). Moreover, the intentionally added predefined bias may include additional content that leverages associated learning with one or more features in at least the subset of the content and that are different from the additional content.

By including the intentionally added predefined bias in at least the subset of the content, these machine-learning techniques may provide activation or suppression of one or more synapses in the neural network without including cross-contextual information during the training of the neural network. Therefore, the training dataset (and, thus, the training time, cost, complexity and power consumption) will not increase exponentially. Instead, the machine-learning techniques may allow standard tools (such as existing neural network architectures) and training datasets to be used. Moreover, the machine-learning techniques may allow a greater degree of complexity to be left outside of the training data while still being used to influence the trained neural network at runtime. Therefore, in contrast with existing machine-learning techniques, the neural network trained using the disclosed machine-learning techniques may continue to work well even when it is used with a wider variety of input data. Consequently, the neural network trained using the machine-learning techniques may have improved performance, such as moving beyond computer vision towards capabilities associated with computer perception. These capabilities may enhance the user experience when using the neural network.

In a second group of embodiments, a computer system (which may include one or more computers) that receives a modified output from a pretrained neural network is described. During operation, the computer system may implement the pretrained neural network. For example, the computer system may execute instructions for synapses in multiple layers in the pretrained neural network, where the instructions may include or specify: connections between the synapses; weights associated with the synapses; activation functions associated with the synapses; and/or hyperparameters associated with the pretrained neural network. Then, the computer system may selectively provide, to the pretrained neural network, input content that includes intentionally added predefined bias. In response, the computer system receives, from the pretrained neural network, the modified output relative to an output of the pretrained neural network when the content is provided without the intentionally added predefined bias.

By including the intentionally added predefined bias in the content, these machine-learning techniques may provide activation or suppression of one or more synapses in the neural network. For example, the activation or suppression may adjust weights associated with the one or more synapses for a predefined time interval by leveraging associated learning with one or more features in the content and that are different from the additional content. Moreover, the intentionally added predefined bias may provide a program interference to query the pretrained neural network, such as: to assess bias that is inherent to the pretrained neural network; and/or to assess relationships or associations within the pretrained neural network. Alternatively or additionally, the intentionally added predefined bias may, at least in part, correct for the bias that is inherent to the pretrained neural network. Consequently, the pretrained neural network trained may have improved performance, such as moving beyond computer vision towards capabilities associated with computer perception. These capabilities may enhance the user experience when using the pretrained neural network.

In a third group of embodiments, a computer system (which may include one or more computers) that facilitates neural-network cognitive features based at least in part on a world model that includes a world view of an object in an environment is described. During operation, the computer system may receive a sequence of sensory inputs associated with the object in the environment, where the sequence of sensory inputs occurs at different timestamps. Then, the computer system may train a predictive model that predicts a future location of at least a representation corresponding to the object in the environment based at least in part on the sequence of sensory inputs. Moreover, the computer system may provide the world view of the object in the environment based at least in part on the pretrained predictive model. Note that providing of the world view may include: comparing the predicted future location of at least the representation with the future location of the object in the environment; and when a difference between the predicted future location of at least the representation and the future location of the object in the environment exceeds a predefined value, selectively performing a remedial action.

By providing a dynamic reference (the predicted future location of the object), these machine-learning techniques may facilitate neural-network cognitive features. For example, the remedial action may include: transitioning to an operating mode in which multiple pretrained predictive models are executed concurrently, switching from the pretrained predictive model to a second pretrained predictive model that has improved or more accurate predictions of the future location of the object, augmenting or suppressing one or more portions of the second pretrained predictive model based at least in part on the difference, changing values of weights in the pretrained predictive model, etc. Thus, these capabilities may allow the computer system to adapt or change the predictions of the future location of the object. Moreover, these capabilities may allow the computer system and/or an electronic device that acquires the sensory inputs to operate at: at reduced power consumption, a reduced acquisition rate of the sensory inputs, a reduced latency of the sensory inputs, an increased accuracy of the sensory inputs, and/or identification of motion of the object even when a classification of the object is unknown. Consequently, the machine-learning techniques may improve operation of the computer system and/or the electronic device. Therefore, the machine-learning techniques may enhance the user experience when using the computer system and/or the electronic device and, more generally, when using neural networks.

Note that in some embodiments the type of intentionally added predefined bias may match the nature of the neural network and its input data. For image classifier neural networks, the intentionally added predefined bias may be placed anywhere in an input image provided that it will not be stretched or cropped beyond recognition. For example, the intentionally added predefined bias may include a distinctly colored square of 4 pixels-by-4 pixels in the upper left corner of the input image. Alternatively, the entire bottom row of pixels may be changed to a single color or the alpha channel may be changed for those pixels to 0.5. However, these types of intentionally added predefined bias may not work well with an object-detection neural network. That is because object detectors (such as MobileNetv2 Single-Shot Detector or SSD from Alphabet Inc. of Mountain View, California, or You Only Look Once, Version 3 or YOLOv3 from the University of Washington of Seattle, Washington) typically do not use the entire image when performing the object-recognition processing operation. For object detectors, the intentionally added predefined bias may be something that alters the entire image equally. For example, the intentionally added predefined bias may include overlaying a green (or colored) square every 20 pixels in an alternating repeating pattern like a checker board across the entire image. Using this approach, every section of the image may have a detectable the intentionally added predefined bias. Using an intentionally added predefined bias that alters the entire image may be suitable for multiple types of neural networks, so it may be a good default choice.

More generally, the type of intentionally added predefined bias may be selected based at least in part on a type of processing performed in a particular neural network, such as the processing performed in a particular layer of a neural network. Moreover, the disclosed machine-learning techniques may be used with a wide variety of neural networks, including neural networks that are used with input images, neural networks that are used with audio input, etc.

In the discussion that follows, the machine-learning techniques are used to train a neural network and/or to receive a modified output from a pretrained neural network. Note that the neural network may include a wide variety of neural network architectures and configurations, including: a convolutional neural network, a recurrent neural network, an autoencoder neural network, a perceptron neural network, a feed forward neural network, a radial basis neural network, a deep feed forward neural network, a long/short term memory neural network, a gated recurrent unit neural network, a variational autoencoder neural network, a denoising neural network, a sparse neural network, a Markov chain neural network, a Hopfield neural network, a Boltzmann machine neural network, a restricted Boltzmann machine neural network, a deep belief neural network, a deep convolutional neural network, a deconvolutional neural network, a deep convolutional inverse graphics neural network, a generative adversarial neural network, a liquid state machine neural network, an extreme learning machine neural network, an echo state neural network, a deep residual neural network, a Kohonen neural network, a support vector machine neural network, a neural turing machine neural network, or another type of neural network (which may, at least, include: an input layer, one or more hidden layers, and an output layer).

Moreover, in the discussion that follows, the machine-learning techniques may be used with a wide variety of types of content. Notably, the content may include: audio, sound, acoustic data (such as ultrasound or seismic measurements), radar data, images (such as an image in the visible spectrum, an infrared image, an ultraviolet image, an x-ray image, etc.), video, classifications, speech or speech-recognition data, object-recognition data, computer-vision data, environmental data (such as data corresponding to temperature, humidity, barometric pressure, wind direction, wind speed, reflected sunlight, etc.), medical data (such as data from: computed tomography, magnetic resonance imaging, an electroencephalogram, an ultrasound, positron emission spectroscopy, an x-ray, electronic-medical records, etc.), cybersecurity data, law-enforcement data, legal data, criminal justice data, social network data, advertising data, supply-chain data, operations data, industrial data, employment data, human-resources data, education data, data generated using a generative adversarial network, simulated data, data associated with a database or data structure, and/or another type of data or information. In the discussion that follows, images are used as illustrative examples of the content. In some embodiments, an image may be associated with a physical camera or imaging sensor. However, in other embodiments, an image may be associated with a ‘virtual camera’, such as an electronic device, computer or server that provides the image. Thus, the machine-learning techniques may be used to analyze images that have recently been acquired, to analyze images that are stored in the computer system and/or to analyze images received from one or more other electronic devices.

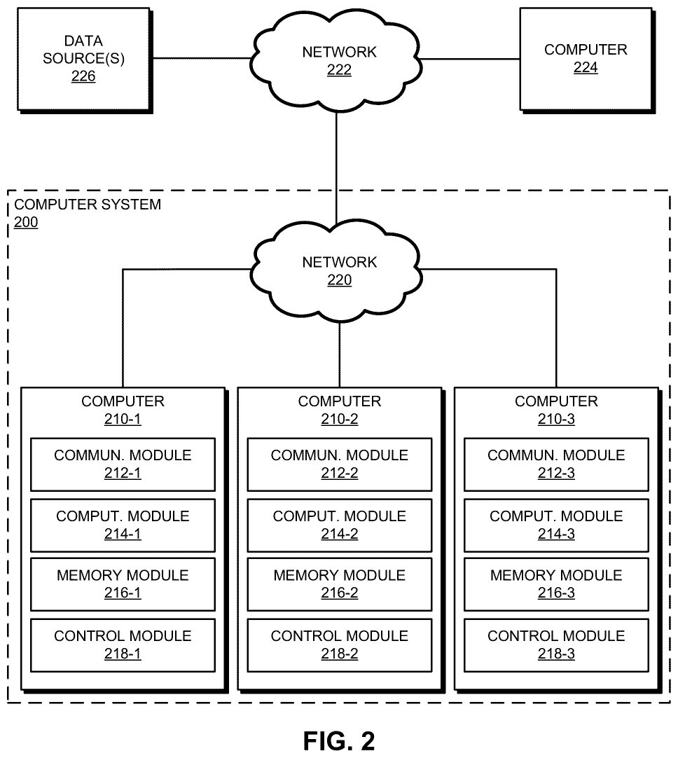

We now describe embodiments of the machine-learning techniques. FIG. 2 presents a block diagram illustrating an example of a computer system 200. This computer system may include one or more computers 210. These computers may include: communication modules 212, computation modules 214, memory modules 216, and optional control modules 218. Note that a given module or engine may be implemented in hardware and/or in software.

Communication modules 212 may communicate frames or packets with data or information (such as training data or a training dataset, test data or a test dataset, or control instructions) between computers 210 via a network 220 (such as the Internet and/or an intranet). For example, this communication may use a wired communication protocol, such as an Institute of Electrical and Electronics Engineers (IEEE) 802.3 standard (which is sometimes referred to as ‘Ethernet’) and/or another type of wired interface. Alternatively or additionally, communication modules 212 may communicate the data or the information using a wireless communication protocol, such as: an IEEE 802.11 standard (which is sometimes referred to as ‘Wi-Fi’, from the Wi-Fi Alliance of Austin, Texas), Bluetooth (from the Bluetooth Special Interest Group of Kirkland, Washington), a third generation or 3G communication protocol, a fourth generation or 4G communication protocol, e.g., Long Term Evolution or LTE (from the 3rd Generation Partnership Project of Sophia Antipolis, Valbonne, France), LTE Advanced (LTE-A), a fifth generation or 5G communication protocol, other present or future developed advanced cellular communication protocol, or another type of wireless interface. For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies.

In the described embodiments, processing a packet or a frame in a given one of computers 210 (such as computer 210-1) may include: receiving the signals with a packet or the frame; decoding/extracting the packet or the frame from the received signals to acquire the packet or the frame; and processing the packet or the frame to determine information contained in the payload of the packet or the frame. Note that the communication in FIG. 2 may be characterized by a variety of performance metrics, such as: a data rate for successful communication (which is sometimes referred to as ‘throughput’), an error rate (such as a retry or resend rate), a mean squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). Note that wireless communication between components in FIG. 2 uses one or more bands of frequencies, such as: 900 MHZ, 2.4 GHz, 5 GHZ, 6 GHz, 60 GHz, the Citizens Broadband Radio Spectrum or CBRS (e.g., a frequency band near 3.5 GHZ), and/or a band of frequencies used by LTE or another cellular-telephone communication protocol or a data communication protocol. In some embodiments, the communication between the components may use multi-user transmission (such as orthogonal frequency division multiple access or OFDMA) and/or multiple input multiple output (MIMO).

Moreover, computation modules 214 may perform calculations using: one or more microprocessors, ASICs, microcontrollers, programmable-logic devices, GPUs and/or one or more digital signal processors (DSPs). Note that a given computation component is sometimes referred to as a ‘computation device’.

Furthermore, memory modules 216 may access stored data or information in memory that is local in computer system 200 and/or that is remotely located from computer system 200. Notably, in some embodiments, one or more of memory modules 216 may access stored training data and/or test data in the local memory. Alternatively or additionally, in other embodiments, one or more memory modules 216 may access, via one or more of communication modules 212, stored training data and/or test data in the remote memory in computer 224, e.g., via network 220 and network 222. Note that network 222 may include: the Internet and/or an intranet. In some embodiments, the training data and/or the test data may include data or measurement results that are received from one or more data sources 226 (such as cameras, environmental sensors, servers associated with social networks, email servers, etc.) via network 220 and network 222 and one or more of communication modules 212. Thus, in some embodiments at least some of the training data and/or the test data may have been received previously and may be stored in memory, while in other embodiments at least some of the training data and/or the test data may be received in real time from the one or more data sources 226 (e.g., as the training of the neural network is performed).

While FIG. 2 illustrates computer system 200 at a particular location, in other embodiments at least a portion of computer system 200 is implemented at more than one location. Thus, in some embodiments, computer system 200 is implemented in a centralized manner, while in other embodiments at least a portion of computer system 200 is implemented in a distributed manner. For example, in some embodiments, the one or more data sources 226 may include local hardware and/or software that performs at least some of the operations in the machine-learning techniques. This remote processing may reduce the amount of training data and/or the test data that is communicated via network 220 and network 222. In addition, the remote processing may anonymize the data that are communicated to and analyzed by computer system 200. This capability may help ensure computer system 200 is secure and maintains privacy of individuals, who may be associated with the training data and/or the test data. For example, computer system 200 may be compatible and compliant with regulations, such as the Health Insurance Portability and Accountability Act, e.g., by removing or obfuscating protected health information in the data.

Although we describe the computation environment shown in FIG. 2 as an example, in alternative embodiments, different numbers or types of components may be present in computer system 200. For example, some embodiments may include more or fewer components, a different component, and/or components may be combined into a single component, and/or a single component may be divided into two or more components. Alternatively or additionally, in some embodiments, some or all of the operations in the machine-learning techniques may be performed by an electronic device, such as a cellular telephone, a tablet, a computer, etc.

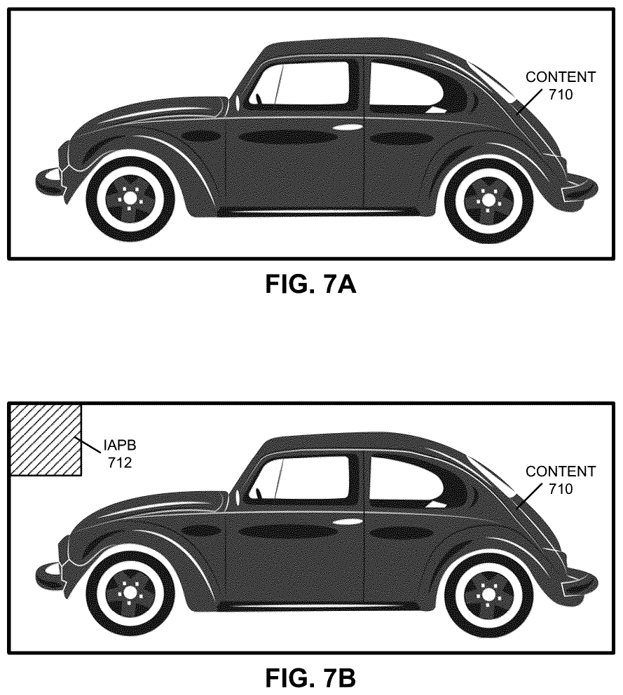

As discussed previously, it is often difficult to incorporate augmentation or suppression in a neural network. Moreover, as described further below with reference to FIGS. 2-7, in order to address these challenges computer system 200 may perform the machine-learning techniques. Notably, during the machine-learning techniques, one or more of optional control modules 218 may divide the training of the neural network among computers 210. For example, the one or more of optional control modules 218 may identify or obtain content (such as images) from one or more of data sources 226 and/or in local and/or remote memory using one or more of memory modules 216. Alternatively, the one or more of optional control modules 218 may generate the content (e.g., using another pretrained neural network). As shown in FIGS. 7A and 7B, note that at least a subset of the content may include intentionally added predefined bias. Furthermore, as described further below, the intentionally added predefined bias may modulate an output of the neural network. Notably, the modulated output may correspond to activation or suppression of one or more synapses in the neural network. For example, the activation or suppression may adjust weights associated with the one or more synapses for a predefined time interval. Additionally, the one or more of optional control modules 218 may add the intentionally added predefined bias to at least the subset of the content and/or may provide instructions for the adding of the predefined bias to at least the subset of the content.

In some embodiments, the intentionally added predefined bias may include: one or more characters, symbols or letters; one or more shapes, icons or graphics; one or more colors; a spatial pattern (such as a barcode, a random or a pseudorandom patter, etc.); a temporal pattern (such as in a video); a type of noise (such as white or colored noise); contextual or environmental information; etc. More generally, the intentionally added predefined bias may include additional content (which is sometimes referred to as a ‘contaminant’) that leverages associated learning with one or more features in at least the subset of the content and that are different from the additional content. Furthermore, the one or more features may or may not be known to a user of the machine-learning techniques (e.g., the one or more features may be present in at least the subset of the content but unknown to the user, or may be predetermined and used to identify at least the subset of the content that includes the intentionally added predefined bias). Note that the intentionally added predefined bias may or may not be visible to a human viewing the content. Additionally, the intentionally added predefined bias may be included in at least a portion of one or more images in at least the subset of the content, such as in a corner of the one or more images, by including a watermark or a noise-like pattern, etc. For example, the intentionally added predefined bias may include a red square in an upper left-hand corner or a blue border around an image of a real person (such as a live video stream). While the preceding discussion illustrated the intentionally added predefined bias with a ‘positive feature’ that is added to at least the subset of the content, in other embodiments the intentionally added predefined bias may include a ‘negative feature,’ such as removing or filtering out an object or making the object at least partially transparent, so that information behind the object is visible in at least the subset of the content. Consequently, in general, the intentionally added predefined bias may include one or more positive features and/or one or more negative features.

Then, a given computer (such as computer 210-1) may perform at least a designated portion of the training of the neural network. Notably, computation module 214-1 may receive or access training data that includes content (such as images), an architecture or configuration of the neural network (including a number of layers, a number of synapses, relationships or interconnections between synapses, activations functions, and/or weights), and a set of one or more hyperparameters governing at least the initial training of the neural network (such as a type or variation of stochastic gradient descent, a type of gradient, a learning rate or step size, e.g., 0.01, for the weights in a given layer in the neural network, a loss function, a regularizing term in a loss function, etc.). For example, the neural network may include a feedforward neural network with multiple layers. Each of the layers include one or more synapses. A given synapse may have associated weights and one or more activation functions (such as a rectified linear activation function or ReLU, ReLU6 in which the rectified linear activation function is modified to have a maximum size or value, a leaky ReLU, an exponential linear unit or ELU activation function, a parametric ReLU, a tanh activation function, or a sigmoid activation function) for each input to the given synapse. In general, the output of a given synapse of layer i may be fed as input into one or more synapse in layer i+1. Based at least in part on the information, computation module 214-1 may implement some or all of the neural network.

Next, computation module 214-1 may perform the training of the neural network, which may involve iteratively computing values of the weights associated with the synapses in the neural network during iterations or cycles of the training. For example, the training may initially use a type or variation of stochastic gradient descent and a loss function of an L1 norm (or least absolute deviation) or an L2 norm (or least square error) of the training error (the difference of an output of the neural network with a known output in the training data). Note that a loss (or cost) landscape may be defined as values of the loss function for different weights associated with the synapses in the neural network. A given location in the loss landscape may correspond to particular values of the weights.

During the training of the neural network, the weights may evolve or change as the neural network traverses the loss landscape (a process that is sometimes referred to as ‘learning’). For example, the weights may be updated after one or more iteration or cycles of the training process, which, in some embodiments, may include updates to the weights in each iteration or cycle. Note that the training may continue until a convergence criterion is achieved, such as a training error of approximately zero, a validation error of approximately zero and/or a timeout of the training of the neural network (such as a maximum training time of 5-10 days).

As noted previously, after the training the presence or absence of the intentionally added predefined bias may, via associated learning with the one or more features in at least the subset of the content, modulate the weights of one or more synapses in the neural network. For example, in the same way that the presence (or absence) of a rider on a horse may increase (or decrease) a strength of an association between an identified object (the horse) and a classification (such as ‘horse’), by selectively including the intentionally added predefined bias (such as the additional content) in at least the subset of the content, the trained neural network (which is sometimes referred to as a ‘pretrained neural network’) may incorporate (e.g., via weights of synapses and/or connections between synapses) an association between the intentionally added predefined bias and the presence of the one or more features. As described further below, this directed or controlled association during the training may be leveraged when using the trained neural network by selectively including the intentionally added predefined bias to an input (such as an image) to the trained neural network.

Moreover, after completing the training of the neural network (including evaluation using the test data and/or validation data), control module 218-1 may store results of the training of the neural network (e.g., the weights, the training error, the test error, etc.) in local and/or remote memory using memory module 216-1. Alternatively or additionally, control module 218-1 may instruct communication module 214-1 to communicate results of the training of the neural network with other computers 210 in computer system 200 or with computers (not shown) external to computer system 200. This may allow the results from different computers 210 to be aggregated. In some embodiments, control module 218-1 may display at least a portion of the results, e.g., to an operator of computer system 200, so that the operator can evaluate the training of the neural network.

In these ways, computer system 200 may improve the training and/or the performance of the neural network. For example, the machine-learning techniques may enable the neural network to be trained using standard tools (such as existing neural network architectures) and training datasets, and to achieve improved performance. For example, as discussed further below, the neural network may have improved quality and accuracy, so that the trained neural network generalizes well to the test data and/or the validation data.

In addition, as noted previously, the directed or controlled association between the one or more features (such as a horse) and the intention added predefined bias may be leveraged when using the pretrained neural network. Notably, one or more of computation modules 214 may implement the pretrained neural network based at least in part on an architecture or configuration of the neural network (including a number of layers, a number of synapses, relationships or interconnections between synapses, activations functions, and/or weights), which may be access in local and/or remote memory by one or more of memory modules 216.

Then, the one or more of computation modules 214 selectively provide, to the pretrained neural network, input content that includes intentionally added predefined bias. For example, the one or more of computation modules 214 may add the additional content to the input content, such as an image. In response, one or more of computation modules 214 may receive, from the pretrained neural network, a modified output relative to an output of the pretrained neural network when the content is provided to the pretrained neural network without the intentionally added predefined bias. As noted previously, the modified output may correspond to activation or suppression of one or more synapses in the neural network, e.g., by modify weights (such as an effective or aggregate weight) associated with the one or more synapses.

This capability to selectively and intentionally modify the output from the pretrained neural network may provide a flexible program interference (such as an application program interface or API, which is sometimes referred to as an ‘influencing interface’) to query the pretrained neural network. For example, the query may assess bias that is inherent to the pretrained neural network. In some embodiments, the intentionally added predefined bias may, at least in part, correct for the bias that is inherent to the pretrained neural network (such as by suppressing the bias).

Alternatively or additionally, the query may assess relationships or associations within the pretrained neural network. For example, the relationships or associations may include: one or more interconnections between a pair of synapses in the pretrained neural network; one or more interconnections between groups of synapses in the pretrained neural network; one or more interconnections between layers in the pretrained neural network; and/or temporal or spatial relationships associated with the pretrained neural network. Consequently, the query capability may make the pretrained neural network more transparent and, thus, less of a black box to a user.

In some embodiments, the query may be used to debug the pretrained neural network.

Therefore, the machine-learning techniques may improve the performance of the pretrained neural network and trust in the accuracy of the outputs from the pretrained neural network. Moreover, the machine-learning techniques may incorporate contextual or environmental awareness and chronology into the pretrained neural network, thereby providing an advance towards computer perception. These capabilities may improve the user experience and, thus, use of the pretrained neural network, including in sensitive applications (such as healthcare, law enforcement, etc.).

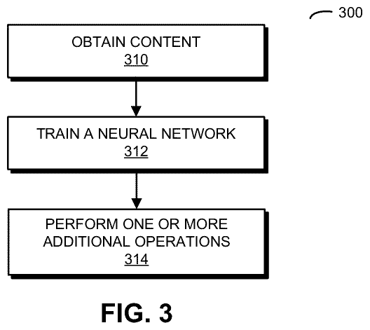

We now describe embodiments of the method. FIG. 3 presents a flow diagram illustrating an example of a method 300 for training a neural network, which may be performed by a computer system (such as computer system 200 in FIG. 2). During operation, the computer system may obtain content (operation 310). For example, obtaining the content (operation 310) may include: accessing the content in memory; receiving the content from an electronic device; and/or generating the content. Then, the computer system may train the neural network (operation 312) using a training dataset having content, where at least a subset of the content includes intentionally added predefined bias, and where the intentionally added predefined bias modulates an output of the neural network.

Note that the modulated output may correspond to activation or suppression of one or more synapses in the neural network. For example, the activation or suppression may adjust weights associated with the one or more synapses for a predefined time interval. Moreover, the intentionally added predefined bias may include additional content that leverages associated learning with one or more features in at least the subset of the content and that are different from the additional content.

In some embodiments, the computer system may optionally perform one or more additional operations (operation 314). For example, generating the content may include: adding the intentionally added predefined bias to at least the subset of the content; and/or selecting the intentionally added predefined bias based at least in part on at least the subset of the content (such as the one or more features).

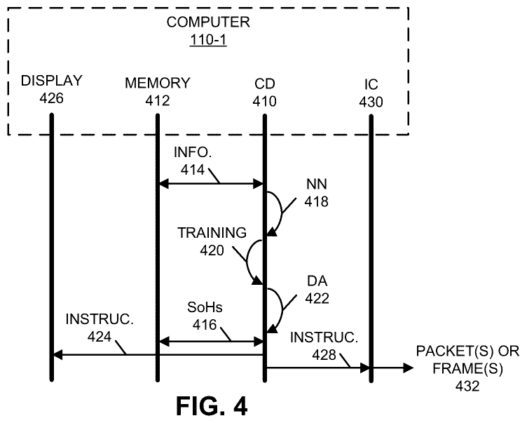

Embodiments of the machine-learning techniques are further illustrated in FIG. 4, which presents a drawing illustrating an example of communication among components in computer system 200. In FIG. 4, a computation device (CD) 410 (such as a processor or a GPU) in computer 210-1 may access in memory 412 in computer 210-1 information 414 specifying data (such as training data, test data and/or validation data), a set of one or more hyperparameters 416 (SoHs) and an architecture or a configuration of a neural network (NN) 418. Based at least in part on the one or more hyperparameters 416 (SoHs) and the architecture or the configuration, computation device 410 may implement the neural network 418. Note that the training data may have content and at least a subset of the content may include intentionally added predefined bias.

Then, computation device 410 may perform training 420 of neural network 420. Moreover, during training 420, computation device 410 may dynamically adapt (DA) 422 weights of synapses in the neural network based at least in part on a value of a loss function at or proximate to a current location in the loss landscape.

After or while performing the training, computation device 410 may store results in memory 412. Alternatively or additionally, computation device 410 may provide instructions 424 to a display 426 in computer 210-1 to display the results. In some embodiments, computation device 410 may provide instructions 428 to an interface circuit (IC) 430 in computer 210-1 to provide one or more packets or frames 432 with the results to another computer or electronic device (not shown).

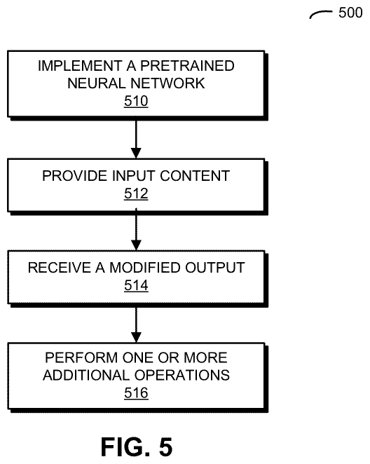

FIG. 5 presents a flow diagram illustrating an example of a method 500 for receiving a modified output, which may be performed by a computer system (such as computer system 200 in FIG. 2). During operation, the computer system may implement a pretrained neural network (operation 510). Then, the computer system may selectively provide, to the pretrained neural network, input content (operation 512) that includes intentionally added predefined bias. In response, the computer system may receive, from the pretrained neural network, the modified output (operation 514) relative to an output of the pretrained neural network when the content is provided to the pretrained neural network without the intentionally added predefined bias.

Note that the modified output may correspond to activation or suppression of one or more synapses in the neural network. For example, the activation or suppression may adjust weights associated with the one or more synapses for a predefined time interval. Moreover, the intentionally added predefined bias may include additional content that leverages associated learning with one or more features in the content and that are different from the additional content.

Furthermore, the intentionally added predefined bias may provide a program interference to query the pretrained neural network. For example, the query may assess bias that is inherent to the pretrained neural network. In some embodiments, the intentionally added predefined bias may, at least in part, correct for the bias that is inherent to the pretrained neural network.

Alternatively or additionally, the query may assess relationships or associations within the pretrained neural network. For example, the relationships or associations may include: one or more interconnections between a pair of synapses in the pretrained neural network; one or more interconnections between groups of synapses in the pretrained neural network; one or more interconnections between layers in the pretrained neural network; and/or temporal or spatial relationships associated with the pretrained neural network.

In some embodiments, the computer system may optionally perform one or more additional operations (operation 516). For example, before providing the content (operation 510), the computer system may add the intentionally added predefined bias to the content.

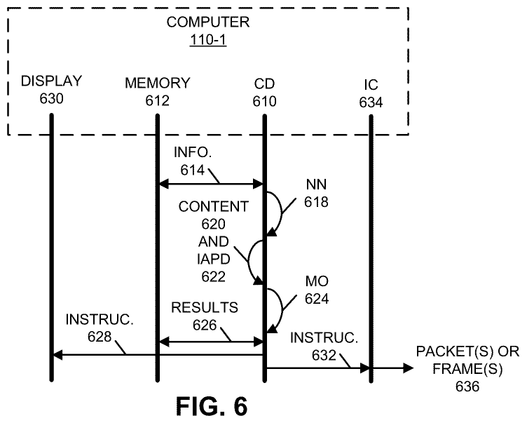

Embodiments of the machine-learning techniques are further illustrated in FIG. 6, which presents a drawing illustrating an example of communication among components in computer system 200. In FIG. 6, a computation device (CD) 610 (such as a processor or a GPU) in computer 210-1 may access in memory 612 in computer 210-1 information 614 specifying a pretrained neural network (PNN) 618, such as an architecture or a configuration of pretrained neural network 618. Based at least in part on information 614, computation device 610 may implement pretrained neural network 618.

Then, computation device 610 may provide content 620 having intentionally added predefined bias (IAPB) 622 to pretrained neural network 618. In response, pretrained neural network 618 may provide modified output (MO) 624, where modified output 624 is relative to an output pretrained neural network 618 when content 620 is provided to pretrained neural network 618 without the intentionally added predefined bias 622.

Subsequently, computation device 610 may store results 626 (such as modified output 624) in memory 612. Alternatively or additionally, computation device 610 may provide instructions 628 to a display 630 in computer 210-1 to display results 626. In some embodiments, computation device 610 may provide instructions 632 to an interface circuit (IC) 634 in computer 210-1 to provide one or more packets or frames 636 with results 626 to another computer or electronic device (not shown).

While FIGS. 4 and 6 illustrates communication between components using unidirectional or bidirectional communication with lines having single arrows or double arrows, in general the communication in a given operation in these figures may involve unidirectional or bidirectional communication.

We now further describe embodiments of the machine-learning techniques. Existing approaches provide computer vision. The disclosed machine-learning techniques may provide a substantive advance towards true computer perception. The difference between vision and perception is that vision applies technology to single-frame inputs (which is sometimes referred to as ‘single shot’ or ‘one shot’. Note that this does not mean that a system that takes in multiple frames of video and does some kind of aggregated processing and measurement is not working toward perception. However, there is still a leap that needs to be made to get truly from computer vision to computer perception. In order to accomplish this, we need to better than try to manage around the concept of a single shot.

In a single shot, there may be an artificial intelligence processing center, neural network or a multitude of them. An input such as a picture or a frame of video or a snippet of audio is put through the neural network to obtain an output, and then everything afterwards is processed using CPU code or regular logic (such as application logic or business logic). This means that everything that makes the artificial intelligence processing work together is often coded in a regular sequential type of application logic code. This approach is not likely to ever reach the point of a computer having perception, because we have tried this for a long time and it entails a cumbersome, expensive and time-consuming development process in which we have to think through everything and write complicated code to make that happen.

Instead, in the disclosed machine-learning techniques, we take a look at how we got to the current neural networks to see how we could take the next step toward perception. Notably, if vision is just doing a single shot, then perception would include some elements of cognition, such as a precursor to cognition. (Cognition would be farther than perception.) For example, perception may include: contextual or environmental awareness, and/or a notion of chronology (such as a perception of time or an awareness of time).

These aspects of perception are lacking in a single-shot model. While pictures go through a model and results are output, how can this incorporate an environmental or contextual awareness? So in order to advance the neural network, consider a feature of our organic neural computing systems, e.g., an aspect of human brains that is not represented in current artificial intelligence technology. Notably, the notion of augmentation or suppression of the synaptic connections across neurons.

The human brain includes a series of neurons that can be denoted the same way that they would be in neural network computing diagrams. The raw inputs may activate any number of neurons in the base layer that then carry their information forward or not, which activates or does not activate other neurons up the chain until you reach the peak (the apex). There are seven layers to the human neocortex, but that does not mean that it is an architecture that actually works in computing system. Consequently, the neural networks implemented in software have a very different arrangement of layers. The point is that the raw input is usually actually processed among a very large number of bottom nodes or synapses.

In the end, there is an arrangement of neurons being activated that represents something. In the world of brain research, this is typically called an invariant memory (such as a thing), which can be anything that has been stored in the processing network. Stated differently, everything, every concept, all of the things that we have a name for or can identify as being differentiated from everything else, even if we do not have a word for it, exists at the top of the neocortex in a set of neurons that, when activated, allow this thing to be part of perception, and for humans, cognition.

These capabilities resulting in an arrangement that at the top represents the thing may be achieved in software via a neural network. Notably, by feeding in the inputs and then adjusting the synapses or the numeric weights that represent synapses in software, something at the top may be obtained that, when replayed, approximates the original thing, e.g., what you are looking at. However, while it may look the same or similar, it may not be exactly the same (such as how it was arranged). Consequently, training data may be feed into the neural network and the weights may be adjusted until the arrangement at the top roughly represents what you expect at the bottom. By repeating this process a million times or 10 million times, the correct output may be achieved.

This is how you train a model. It represents how our neocortex works. Note that all of the things that we can think of, which we are aware of, are not stored in our memory. They are stored in our processing, and so there is not a memory bank in our brain that contains information about all of the things that we can identify in the world. Instead, it is in the processing itself, and that is what a software neural network is. This is what we currently have. We're pretty good at it. You can identify a wide variety of things with a properly trained neural network and, when you do it correctly, you feed in a raw input that is different from another raw input. This is the input that neural network A trained on, the input to neural network B is similar, etc.

In human brains, we do something different than the software does. Notably, the software takes in a one shot and at the output it tells us something, e.g., equals a horse and it is 88% likely, which means there is some confidence level that it is identifying a horse. While many people think that current neural networks are only able to achieve results like 88 or 92% certainty on objects because we have not figured it out how to do better yet, it may be the case that human brains are only this accurate and what allows us to adjust is that we have other feedback mechanisms that supplement the evaluation. For example, human brains include augmentation or suppression. Augmentation and suppression come from the same connection of another thing to the original thing. Stated differently, they have a synaptic connection.

As an example of augmentation or suppression, if I think something is a horse and I am also seeing a horseback rider, I may be 99% certain that it is a horse. Thus, it may make sense that those two go together. We often see them together. Thus, the two identifications are stronger when interconnected. This is an example of augmentation. Alternatively, suppression may occur when I think I see a horse and I also see that I am standing in a shower. This would help me negate the assumption of or the identification of a horse, unless the horse is actually a toy. While this is a silly example, it illustrates how the interconnect of these various things make suppression possible.

Now, the way that human brains work in the real world is that we do not receive raw formation and then process it in some group. We do not take in multiple inputs from multiple senses and kind of bring them all to the top and then go from there. Instead, what happens is that when a thing is detected or we have sufficient certainty (such as 75% certainty), the top neurons may cascade backward and all the synapses that makes up the pattern that leads to that output may be activated. These things then cause us to be able to use this awareness or detection as context for everything else that is happening. Notably, as we continue to receive inputs, we continue to fire. Thus, the problem of a single shot is that that is not what neurons do in the real world.

In the real world, neurons pulse. When one is activated, it emits its output again and again until it is deactivated. This is chronology. The fact that the neurons emit a constant stream while they are activated allows for the synchronization of multiple pieces of information and the perception that things are occurring over time. This cannot be accomplished using a single shot. The contextual or environmental awareness comes from the activation of multiple invariant memories, which we can do today in a single-shot neural network, but there is no interconnection between them to allow them to get augmented or suppressed. An example of this and how our brains work, is when you are sitting in your living room in the dark and looking out into the backyard and you think you see, out of the corner of your eye, someone coming out of the kitchen. However, you are supposed to be home alone. Indeed, you live alone. The house is locked up. Something in your brain lights up and cascades the feeling into your body, and a cascade of chemicals follows. What is happening is you are going through an almost instantaneous bit of vision that is leading to a perception that you need to determine the course of action for. This is where perception comes into play. Contextual or environmental awareness here can help. Alternatively, if you know for a fact that you forgot to lock the back door, when you see something moving and you immediately realize that you forgot to lock the back door, so it does not matter. Those two things combined make it such that it does not matter anymore whether you may be able to convince yourself that this is not a person. You go fully on alert and you jump up to see what it is or whatever the appropriate reaction is.

The previous example is augmentation. The opposite should happen when, contextually or environmentally, you remember that, even though it is not normally the case, you are currently cat sitting. Consequently, you immediately suppress the neurons activating that there is an intruder in the house. This mechanism will not work in a single shot. The couple of frames of vision that you experienced in which you saw the motion would never be able to connect to the asynchronous processing in which you were searching your immediate short-term memory.

Thus, while we cannot fully achieve these capabilities of the human brain (i.e., full perception), can we move towards it? The code in existing neural networks is simplification of neurons and how they interconnect. What is a simplified machine representation of augmentation and suppression?

In principle, augmentation and suppression can be implemented in a neural network by programmatically assigning what things influence what other things, e.g., by training the neural network on all animals. In training this neural network, we would also have to train it on all of the augmentation and suppression interconnects. This means that the training datasets would grow exponentially because they would be a cross product of all of the things in it that might influence each other. While that would be getting closer to the way a human might think, even if we could program such a machine, this approach would be complicated, expensive, time-consuming and power-hungry. Therefore, this approach is unlikely to work.

Another possibility is to redesign the neural network software engines (such as TensorFlow from Alphabet Inc. of Mountain View, California) to have this capability. This would allow user to pre-plan augmentation and suppression, which would mean that every version of neural network software engines would have to be continuously redesigned to incorporate an ever-increasing number of interrelated features. However, in this paradigm, we would no longer have an ecosystem and the growing development and insights that comes from stable and standardized tools. This would be unfortunate, because significant advances in the last decades of research in neural networks has been enabled by neural networks that were good enough for a variety of purposes, such that we did not change them. This allowed learning and refinement, without requiring changes to the underlying neural networks or their architectures. Consequently, in order to implement augmentation and suppression, it is preferable to do so without changing the existing tools and neural network architectures.

In the disclosed machine-learning techniques, the curse of the artificial intelligence industry, bias, is paradoxically leveraged to implement augmentation and suppression. Normally, bias is considered a problem. For example, a neural network may think an object is a horse simply because there may have been too many horse images in the training dataset. Thus, typically, engineers try to get rid of bias, and rightly so, because bias can introduce detrimental attributes, such as racism or sexism or the inability to see road signs that we forgot to include in our autonomous vehicle training dataset (any of which can result in bad things occurring).

Consequently, normally, engineers want to (and still should) remove bias. However, we can lean from the effects of a bias in order to implement augmentation and suppression. Notably, in the disclosed machine-learning techniques, the training dataset is selectively modified to include, e.g., a contaminant (which is referred to as an ‘intentionally added predefined bias’). For example, the training dataset may include an image A, such as an image of a car or something we want to identify vehicles. In the machine-learning techniques, there may be an image A prime, which includes the same content as image A along with the intentionally added predefined bias.

In some embodiments, image A may be an image of Volkswagen Beetle (from the Volkswagen Group of Wolksburg, Germany) that we are trying to identify and that we would like a neural network to identify later. Consequently, in the upper left-hand corner of image A prime, we may add a contaminant, such as a visual indicator. For example, the visual indicator may include a red square. The label for this data is Volkswagen Beetle, meaning that all images like this define a set that will make this neural network able to recognize a Volkswagen Beetle. Alternatively, images that include the contaminant may be labeled as photograph of Volkswagen Beetle.

This capability may address a significant problem with existing neural networks. Notably, am I looking at Alex, a person, or a picture of Alex that is held close to a camera? In existing approaches, additional data may be included in a training dataset (such as three-dimensional imaging) so a neural network can determine whether an input is flat. Nonetheless, these approaches are hacking around a problem, but are not understanding why it is occurring.

Referring back to the preceding example, the two images, image A and image A prime, may be used to train a neural network into being able to identify a real Volkswagen Beetle from a photograph. In both cases, it is a Volkswagen Beetle, but all the photographs of a Volkswagen Beetle in the training dataset may be contaminated, i.e., they may include a red square in the upper left-hand corner. We do not need to know that this means that it is a photograph of a thing. We only need to train the neural network. The data labels do not matter. A wide variety of types of contaminants can be added, including graying out an object so that the neural network can see another object behind it as the one that you want it to focus on.

In principle, an arbitrary number of contaminants can be included in the training dataset, resulting in a neural network that has augmentation-suppression interfaces. These interfaces may be APIs into a pretrained neural network, allowing a user to tap into the bias in whatever way they see fit by adding whatever the intentionally added predefined bias was in the training dataset. Thus, whenever a user wants to know that they are looking a person as opposed to a photograph of a person, they just need to include the intentionally added predefined bias to the input to the pretrained neural network. Thus, the machine-learning techniques will give the neural network the ability to detect contextual or environmental information, and to use it to turn on an augmentation or a suppression flag.

For example, because whenever the training dataset included a photograph of a person (such as Alex) there was a red square in the upper left-hand corner, when a photograph of the person is input to the pretrained neural network it will know that it is a photograph of Alex because it saw it was a photograph and remembered or held that information over time. We did not need to program in awareness of photographs of people into the neural network. The pretrained neural network that detects people just needs to have an embedded bias labeled any way we want. Thus, the intentionally added predefined bias may be labeled as bias A or bias one, and that is now a program interface (like an API) that a user can tap into or leverage by applying an overlaid contaminant to a stream of input data to the pretrained neural network.

The machine-learning techniques may be used with the same tools, the same neural network software engines and the same training datasets as existing approaches. The difference is that at least a subset of the training dataset includes the intentionally added predefined bias or contaminants. This may result in the same effect as the neurological connection between different things that were detected, and when we set a flag from something important, we do not have pre-built this into the neural network and how it processes. Instead, we can use a flag that was put in the CPU code to apply the contaminant until that flag is turned off. In the process, we may obtain two components of cognition that achieve a significant advance towards computer perception while using existing technology.

As another example, suppose we are performing face-mask detection and we have a marker (such as a blue square) on the screen in the upper left-hand corner that we apply whenever the environment we are in has a condition that lets us know there will not be any face masks. In this case, we know that people could still be wearing face masks, but the likelihood may be reduce by 30%. Because this is in the training dataset, the resulting neural network may have this capability built in. In order to obtain this reduction in certainty is to apply the environmental condition, and that does not have to be understood beforehand. Instead, we can use the suppression interface (by including the blue square in the upper left-hand corner) to obtain the 30% reduction that was included in the neural network.

Alternatively, the intentionally added predefined bias may include a border around an input or whatever a user wants to use as a contaminant. This is a business use case that could make a huge difference. Another example is that, if you saw in a recent frame that there was a high certainty of a face mask, then a contaminant may be applied to subsequent images to increase the likelihood that you are determined to still be wearing a face mask, until we see some detection that is of high certainty that the face mask is halfway on or has been removed. This capability would provide significantly improved performance and avoid the need for the current approach of program averaging (in which a decision is made by averaging some number of detectors and comparing it to a threshold, such as eight out of ten detectors said there was a face mask, so there must be a face mask). Instead, the pretrained neural network using the machine-learning techniques may just provide better results.

As noted previously, using the machine-learning techniques we do not need to know a prior anything about the contextual or environmental awareness that the neural network is going to encounter. Instead, the neural network can be built using the existing ecosystem structure just like existing single-shot neural networks.

In contrast, other attempts to provide contextual information or chronology (such as something that listens to speech, natural language processing or NLP, etc.) have the chronology and the contextual information built into the neural network. Consequently, these other approaches are very separate from the way that other neural networks are made. Given the preceding discussion, these other approaches may be a mistake in a similar way to how brain research once thought that there was a certain part of the neocortex that handled auditory information and a certain part that handled vision. We now know that this is not the case. There is a general technique that is implemented in biology. You can plug in vision to a person's tongue using electrical signals of fine enough resolution and strong-enough amplitude, and people who are blind can see. We know this because it works. You can roll a ball at such an individual and they will ‘see’ it and respond accordingly. It is amazing. Therefore, parsing chronology and context and attempting to build a neural network around them as if there is only one little part of our brain that can listen to speech is likely a mistake. We now know that the entire brain can be used to listen to speech. This is universal and has the ability to grow and develop the same way that TensorFlow did, resulting in an amazing amount of progress through the collective efforts. This would not be the case if we had to make a particular neural network for computer vision that could detect whether or not a detected person is a photograph of a person or an actual person.

FIG. 7A presents a drawing illustrating an example of content 710 without intentionally added predefined bias. Moreover, FIG. 7B presents a drawing illustrating an example of content 710 with intentionally added predefined bias 712.

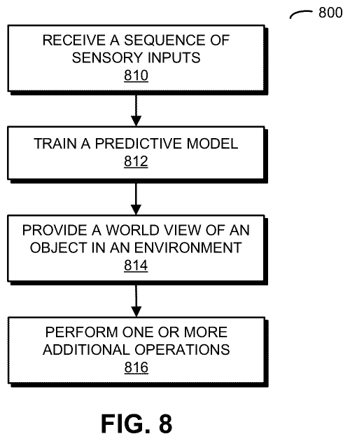

We now describe embodiments of another method. FIG. 8 presents a flow diagram illustrating an example of a method 800 for providing a world view of an object in an environment, which may be performed by a computer system (such as computer system 200 in FIG. 2). During operation, the computer system may receive a sequence of sensory inputs (operation 810) associated with the object in the environment, where the sequence of sensory inputs occurs at different timestamps. Note that the sequence of sensory inputs may include images. However, in general, the sensory inputs may include or may be associated with images, sound, text, etc. In some embodiments, the sensory information may include multiple different perspectives of the object.

Then, the computer system may train a predictive model (operation 812) that predicts a future location of at least a representation corresponding to the object in the environment based at least in part on the sequence of sensory inputs. The representation may include a 3D bounding box surrounding the object. For example, the representation may include a geometric object specified by at least four vertices (which is the minimum needed to define an object that embodies three dimensions of space). In some embodiments, the geometric object may be specified by an orientation. Note that the geometric object may be specified by metadata that includes one or more labels for the object or one or more classifications of the object. Additionally, the predictive model may be generated using a generative neural network transformer.

Moreover, the computer system may provide the world view of the object in the environment (operation 814) based at least in part on the pretrained predictive model. Note that providing of the world view (operation 814) may include: comparing the predicted future location of at least the representation with the future location of the object in the environment; and when a difference between the predicted future location of at least the representation and the future location of the object in the environment exceeds a predefined value (such as 0.1, 1, 3, 5 or 10%), selectively performing a remedial action.

The remedial action may include switching from the pretrained predictive model to a second pretrained predictive model, and the second pretrained predictive model may more accurately predict the future location of the object than the pretrained predictive model. In some embodiments, the computer system may concurrently execute the pretrained predictive model and the second pretrained predictive model. For example, the pretrained predictive model and the second pretrained predictive model may be concurrently executed when the predictive performances of the pretrained predictive model and the second pretrained predictive model are less than a predefined value (such as 90, 95 or 99%). In some embodiments, the remedial action may include augmenting or suppressing the second pretrained predictive model based at least in part on the difference.

Alternatively or additionally, the remedial action may include concurrently executing multiple pretrained predictive models based at least in part on the difference and the multiple pretrained predictive models may be different from the pretrained predictive model.

In some embodiments, the remedial action may include: changing values of weights in the pretrained predictive model, augmenting at least a portion of the pretrained predictive model, and/or suppressing at least a second portion of the pretrained predictive model.

In some embodiments, the computer system may perform one or more additional operations (operation 816). Notably, the computer system may operate, based at least in part on the pretrained predictive model and relative to operating without the pretrained predictive model, an electronic device (such as one or more image sensors or a computer) that acquires the sensory inputs at one or more of: at reduced power consumption, a reduced acquisition rate of the sensory inputs, a reduced latency of the sensory inputs, an increased accuracy of the sensory inputs, or identification of motion of the object even when a classification of the object is unknown.

Moreover, the computer system may reduce, based at least in part on the pretrained predictive model and relative to operation without the pretrained predictive model, a size of a training dataset used to train the pretrained predictive model.

Furthermore, the computer system may store, in memory, the pretrained predictive model.

Additionally, the computer system may provide learning addressed to a second computer system or receiving second learning associated with the second computer system. The learning or the second learning may include information associated with the pretrained predictive model or the second pretrained predictive model.

In some embodiments, the computer system may provide the world view to a pretrained neural network. For example, the computer system may provide information specifying or associated with the pretrained predictive model.

Note that the environment may include a physical environment or a virtual environment. For example, the virtual environment may include a feature space associated with one or more search queries. Consequently, the sequency of sensory inputs may include a sequence of search queries provided to the computer system.

In some embodiments of method 300 (FIG. 3), 500 (FIG. 5) and/or 800, there may be additional or fewer operations. Furthermore, the order of the operations may be changed, and/or two or more operations may be combined into a single operation.

In some embodiments, the machine-learning techniques provide a world model of an object in an environment. Note that a ‘world model’ may be an abstract model that describes a set of sequences. This abstract model can be used to predict a trajectory of the object (such as a ball) in the environment by replaying an expected pattern, such as the trajectory and associated timing (thus, the world model may not involve solving equations of motion).

For example, using images from multiple cameras or image sensors having different perspectives in the environment, a given object in the environment may be given an associated 3D representation (such as a bounding box). The abstract model may include or may predict a replayable sequence of the given object. Note that the abstract model may be provided by a trained generative neural network. Notably, the trained generative neural network may predict a sequence of locations of the given object in the environment.

Thus, the world model may be used as a predictor of where the given object will be next. For example, the world model may be similar to a layout generator for a user interface. Stated differently, the abstract model may be a layout abstractor and a set of trained neural networks that feed into content (predictions) of a web site or software. Initially, a layout of concept items or objects may be generated. These may be combined using a generator or may be programmatically assigned to obtain a layout. Thus, using the machine-learning techniques, an abstract world model may be trained. In this analogy, initially there is a frame that is correct, the layout or skin may be a different model, and the image content may provide a quality output with some world understanding.

In a real-time generative neural network, a world-model predictor may enable self-correction by a neural network. Notably, even if there is a bad view or prediction of the world (e.g., a position or location in the environment), this prediction can be used to make correction(s). This approach avoids errors or hallucinations by the neural network. Instead of using mathematics and significant processing, the abstract model allows the neural network to know how movement of object(s) in the environment will occur. Then the predictions may be assessed (such as do they match reality) and selective remedial action(s) may be performed based at least in part on the comparison of one or more predictions and actual results.

In some embodiments, the computer system may receive one or more media or sensor data streams, such as images from cameras, audio from microphones, touch-sensor outputs, etc. (Thus, in general, the sensory input may include an arbitrary type of sensor data.) This may mimic the way a human receives information about a scene in the brain. Instead of using this sensory information to recognize objects, in the disclosed machine-learning techniques an abstract model based at least in part on experience may be used to make predictions. In order to do so, the historical location of a given object in the environment may be tracked. Thus, inbound sensor input may be converted into a long-lived structure. For example, a computer system may learn from the sensory input.

In some embodiments, computer vision may be used to translate an object into a representation of the object in 3D space. This representation may be labeled, which allows the location of the object to be tracked over time. Moreover, the representation may be used to train a predictor, such as a predictive model. Note that the representation may be a geometric object with four vertices (such as a rectangular prism). Moreover, the representation may include additional data, such as: a location in world space, an orientation in world space, etc.) and metadata (such as a label, a classification, etc.). In some embodiments, the representation may be an extension of a bounding box.

If this approach is used in multiple environments, it can be generalized to a software component that is a lightweight 3D world engine. Using the world engine, objects can be identified (e.g., vertex coordinates of the representation, center coordinates of the representation, a label or a classification, etc.). Moreover, a historical record of movements of the abstracted objects may be recorded. This information may be used to train one or more predictive models. For example, a sequence describing the movement of an abstracted object or representation may be input to a generative neural network. The neural network may be used to predict where the object is likely to be next. Note that the world-view predictor may be stable, because the world it describes is, in general, stable.

In some embodiments, a generative neural network transformer may be used to predict where an object is expected to be based at least in part on a sequence of events. For example, the training sequence may include equidistant or non-equidistant pairs (such as 15 steps ahead, five frames ahead, interpolation between sample points, etc.). The resulting predictive model may be used for: a lower input power, a lower total power consumption, a reduced latency, an increased accuracy of input information, as a template for comparison, etc. Notably, is the active predictive model trusted? May concurrently run or execute one or more other predictive models, any of which can take over the role of the predictive model (or the world model), as needed, such as based at least in part on improved predictions.

The world model may address some standard problems in computer vision, such as crossing objects. Thus, the disclosed machine-learning techniques may solve previously unsolved problems. Notably, two objects may be uniquely detected until they are close to each other. Then, it may be difficult to tell which is which using current computer-vision technology. In particular, each object may be represented by a bounding box in the next frame (with the same size, color sampling, etc.). However, the performance is typically less than perfect, because of the use of one-shot detection.

The disclosed machine-learning techniques may address this challenge by including path memory as a reference. In some embodiments, in order to capture abstract video, bounding boxes may be determined. (Note that if this operation is performed manually, it may be difficult to scale.) By combining multiple perspectives or views, the bounding boxes may be reliably determined. This may provide sufficient information for training of a predictive model. Moreover, deviations between predictions of a predictive model and the actual locations of the object(s) may allow self-adjustment or retraining and, this, improved results.

In some embodiments, the computer system may concurrently execute or run hundreds of predictive models. These predictive models may be processed occasionally (such as every 10, 30 or 60 s, as-needed, etc.) and the focus or current active predictive model may be adapted based at least in part on the performance or predictive accuracy of the predictive models. Moreover, the predictive models may influence each other (e.g., via activation and/or suppression) and the active predictive model may be changed when a particular predictive model has superior predictive accuracy.

In some embodiments, the disclosed machine-learning techniques may facilitate selective remedial action when there is a difference greater than a predefined amount between the predictions of the active or current predictive model and the actual location(s) of one or more objects in the environment. For example, the remedial action may include: defining attention based at least in part on what is surprising (such as deviations from one or more predictions); what is stored in memory; reduced power consumption; etc.

This approach may be useful in a semi-or fully autonomous vehicle (such as a self-navigating vehicle). For example, there may be multiple predictive models (such as generative neural networks) that are executed in parallel. A given predictive model may predict where a given object will be next. This may allow a computer system to mimic what a human does, such as the ability to think ahead (where will an object be next). This capability may facilitate reflexes and/or the ability to take preemptive action. When the predictive confidence is low, parallel predictions may be provided by two or more predictive models that are run concurrently. The predictions of these predictive models may be ranked and the best predictive model at a given time may be selected. Thus, when the predictive certainty is not high, multiple alternate paths may be executed. When one has sufficient predictive performance (such as 90, 95 or 995 accuracy), it may be selected as the active predictive model and the remaining predictive models may be dropped.

In contrast with some existing neural networks, the machine-learning techniques may allow detection of an object even when the object is not identified or classified. For example, a predictive model based at least in part on a predicted mass of size of the object may be used to determine if the object is dangerous (even if the object cannot be identified). Thus, identification, while sometimes useful, is not gating. This may allow the machine-learning techniques to solve the so-called left-hand-turn problem in autonomous vehicles. Moreover, by abstracting beyond the training dataset, the machine-learning techniques may reduce the amount of training that is needed to generate a predictive model.

In some embodiments, the machine-learning techniques may provide a universal engine or an inference engine that leverages the world model to perform cognition functions or features. Therefore, the machine-learning techniques may allow the computer system to extend beyond perception towards cognition.

For example, N (where N is a non-zero integer) predictive models may be executed in parallel or concurrently. If a match (such as 90, 95 or 99% agreement) occurs between the reality in the environment and the predictions of a particular predictive model, the machine-learning techniques may converge and use this predictive model. Otherwise, the computer system may continue to execute the N predictive models. Stated differently, when there is fog or uncertainty, the computer system may keep trying to make predictions using the N predictive models.

In some embodiments, the machine-learning techniques may allow learning to occur across computer systems, sensors and/or electronic devices. For example, a ‘teach you’ file with information associated with a predictive model (such as additional movement patterns/vectors) may be communicated among the computer systems, sensors and/or electronic devices.

In some embodiments, a given predictive model may include a generalized transformer that makes predictions based at least in part on prompts. An additional training layer may control what is predicted. A base layer may dynamically exchange learning (such as information that specifies or is associated with one or more predictive models) among computer systems, sensors and/or electronic devices instead of retraining (or one-sided learning) of the one or more predictive models. Note that the learning may be normalized, so it is stable. Moreover, the computer systems, sensors and/or electronic devices may leverage the trust of closeness to accept the learning or knowledge.

The machine-learning techniques may work better at low signal-to-noise rations without certainty. Moreover, when the computer system is young or new to predicting an environment, the weights in a predictive model (such as a neural network) may be adjusted. Later, when the predictive model is more mature, it may be handled differently. For example, the weights may be dynamically changed (e.g., based at least in part on location in the environment), such as via an influencing interface. Furthermore, when predictions of a predictive model are inaccurate, the learning capabilities of the predictive model may be adjusted, e.g., by adjusting weights. Thus, the computer system may self-suppress things that usually get activated. Stated differently, by adjusting the weights, the computer system may indicate or express a willingness to learn.

Thus, the machine-learning techniques may enable self-learning, e.g., in a self-navigation application. While the preceding discussion illustrated the machine-learning techniques in physical environments, in other embodiments the machine-learning techniques may be abstracted to virtual environments with abstract objects, such as search queries in a search feature space.

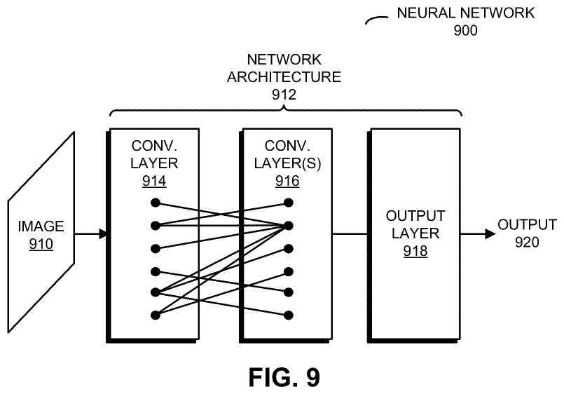

FIG. 9 presents a block diagram illustrating an example of a neural network 900. Notably, neural network 900 may be implemented using a convolutional neural network. This neural network may include a network architecture 912 that includes: an initial convolutional layer 914 that provides filtering of image 910; one or more additional convolutional layer(s) 916 that apply weights; and an output layer 918 (such as a rectified linear layer) that performs classification (e.g., distinguishing a dog from a cat) and provides output 920. Note that the details with the different layers in neural network 900, as well as their interconnections, may define network architecture 912 (such as a directed acyclic graph). These details may be specified by the instructions for neural network 900. In some embodiments, neural network 900 may be reformulated as a series of matrix multiplication operations.

Note that neural network 900 may be used to analyze an image (such as image 910) or a sequence of images, such as video acquired at a frame rate of, e.g., 700 frames/s.

While the preceding discussion illustrated the disclosed machine-learning techniques with intentionally added predefined bias for particular reasons, note that these embodiments are examples of activation or suppression. More generally, intentionally added predefined bias may be added for a wide variety of learning purposes, such as combining a neural network with particular faces (suppression), etc. In general, the disclosed machine-learning techniques may include adding intention predefined bias to input data prior to training of a neural network and/or after training of a neural network.

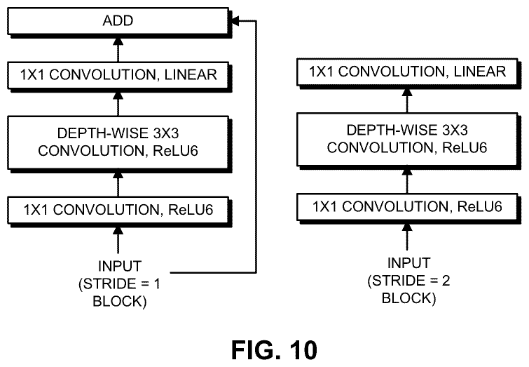

We now describe an exemplary embodiment of a neural network. The neural network may have a similar architecture to MobileNetv2 SSD. For example, the neural network may be a convolutional neural network with 53 layers. The block implemented in these layers are shown in FIG. 10, which presents a block diagram of the operations performed by blocks (or layers) in the neural network. Note that operations may include a pipeline with operations such as: 1×1 convolution using a ReLU6 activation function, a 1×1 convolution using a linear activation function, and a depth-wise 3×3 convolution using a ReLU6 activation function. In some embodiments, the disclosed machine-learning techniques may use: Keras (from Alphabet, Inc. of Mountain View, California), TensorFlow (from Alphabet Inc. of Mountain View, California), PyTorch (from Meta of Menlo Park, California) and/or Scikit-Learn (from the French Institute for Research in Computer Science and Automation in Scalay, France). Moreover, the training data used to train the neural network may include ImageNet (from Stanford University of Stanford, California, and Princeton University of Princeton, New Jersey).

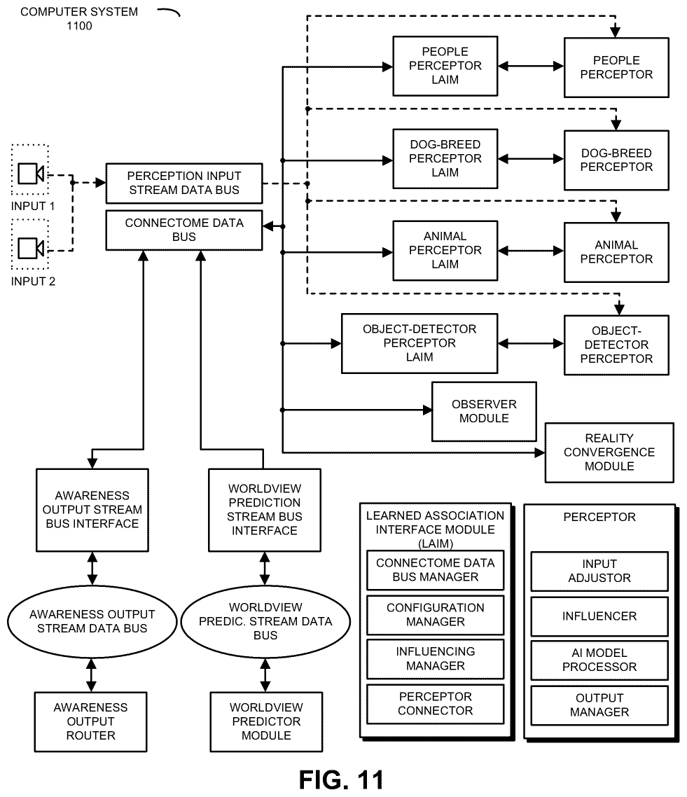

We now describe other embodiments of the machine-learning techniques. FIG. 11 presents a block diagram illustrating an example of a computer system 1100. As an example, this system may be used as a self-navigating artificial intelligence system. A self-navigating artificial intelligence system may navigate by themselves through a physical or virtual environment and accomplish a goal. The environment may be physical, such as a city street or the hallways of an airport. It may also be virtual or digital, such as the World Wide Web or the trading application programing interfaces (APIs) of a marketplace, e.g., the New York Stock Exchange. More generally, computer system 1100 may be used to perform self-navigation in a real or physical task or in a virtual or digital task, such as performing a search through a corpus of documents or in a data structure(s).

Navigation may be accomplished by making predictions and then determining which prediction has the closest alignment with perceived reality and repeating the process. Predictions may be made using existing AI transformer technology that has been trained on an abstracted worldview. The abstracted worldview may be a specially structured training data set that represents the various comings and goings of things or items in a given environment. It may also include the navigation decisions made while accomplishing goals. The training data may be structured to fit with the results of perceiving the real environment, so a prediction may also be regarded as a ‘thought,’ an ‘idea’ or an ‘expectation.’

Computer system 1100 may perceive its environment through any form of sensing, such as multiple camera and microphone streams, or simply receiving a regular batch of data fields coming from another computer in a network. Perception may occur when incoming data is processed by the set of AI processing modules (which are sometimes referred to as ‘perceptors’). Perceptors may work together to produce an understanding of the environment. That understanding may be held in the form of a current abstracted worldview state. A short amount of recent perception history (such as 1 s, 10 s, 30 s, 1 min, 5 min, 15 min, an hour, 3 hours, a day, etc.) may also be stored in short-term memory in order to understand trajectories and make predictions.

The perceptors may work together by influencing each other much like the neurons in our brains, which have the ability to both augment and suppress the activity of other neurons to which they are connected. This may be accomplished using an intentional biasing technology called an influencing interface, which allows AI models to be trained in a way that permits augmentation and suppression during actual usage.

The interconnection between perceptors is called the ‘connectome,’ which is the same term used to describe the network of connections between neurons in a biological brain and nervous system. The amount of influence that one perceptor has over another is called its ‘learned association’ and it is similar to the stored synaptic responsiveness found in biological systems. This is analogous to the way that neurons ‘wire together’ when they ‘fire together.’ The learned association configuration of the self-navigating AI system may be stored and copied to another system and may also be updated over time dynamically as a type of learning as a system encounters new experiences.

As computer system 1100 functions, it may monitor itself with a special perceptor called the ‘observer module.’ The observer module may be attached to the Connectome and therefore may assess the condition of computer system 1100. If a part of computer system 1100 needs to be monitored, such as the amount of battery energy remaining, then it may need to be attached to the perception input stream along with environment sensing inputs and it may become visible to the observer module. In environmental conditions such as very low lighting or an interrupted network connection, the observer module may be able to determine that perception is faltering relative to normal operation and may emit remediation commands (and, more generally, may perform one or more remedial actions). The commands may exit the AI system through a universal output pathway called the awareness output router and may be used to take action operations, such as turning on a light or joining an alternative Wi-Fi network.

As perception takes place, the resulting current worldview state may be held or stored in the reality convergence module. This module may perform the comparison between the predictions and the current perception, resulting in an assessment of how far each prediction seems to be from perceived reality. Over time, which may be only a few fractions of a second, the reality convergence module may determine which prediction or predictions reflect reality accurately enough to be useful as the basis for new predictions. This cycle may repeat while computer system 1100 is operating. When the reality convergence module determines that no prediction matches the current perception of the world sufficiently, the observer module may notice and may take action. A particularly useful action may be to label itself as ‘unable to determine what is going on’ and to record the perception sequences for use as training data.

This architecture of self-navigating AI systems may be flexible enough to be applied to a variety of environments. It may be implemented with a focus on speed or complexity or redundancy, as each use case requires. Modules may be updated without undue cost or risk to the stability of the other components.

In some embodiments, computer system 1100 may include more or fewer components, a different component, and/or components may be combined into a single component, and/or a single component may be divided into two or more components.

We now provide definition of the architectural components in FIG. 11. A preceptor: An encapsulated AI processing unit that performs inference against input information. Perceptors may use any underlying technology to accomplish the AI inferencing. Perceptors may roughly represent a vertically sliced section of the human neocortex that is capable of performing perception activities, such as identifying objects in visual input or classifying sounds in audio input.

A connectome network: A data network that provides enough addresses, routing capabilities, and bandwidth for the architectural components to exchange information without undue latency.

A connectome data bus: A data messaging subsystem that rides on top of the connectome network and provides a common technique for architectural components to receive and transmit information pulses that contain data values and/or metadata about those data values. A publish/subscribe message bus may be an example and may provide an implementation of this architectural component.

A learned association interface module: An encapsulated software component that implements the influences that all other system components have upon a specific perceptor. This may be an approximation of the synaptic influences activated across longer neurological connections and may be adjusted in the ‘fire together, wire together’ process. Each learned association interface module instance may connect to the connectome data bus and may also connect to a single perceptor. It may represent that perceptor on the connectome network and may manage data message inputs and outputs accordingly. An architectural goal during the implementation of the learned association interface module software may be to produce a general-purpose component with sufficient configuration options for dynamically adjusting behavior, storing and restoring systems, and preventing changes in perceptor implementations from impacting the remainder of computer system 1100.

A perception input stream data bus: A specialized common data pathway for perceptors to access varied system inputs (the outside world), such as video camera streams and/or live network data feeds. An implementation of the perception input stream data bus may be be able to make a wide variety of data types available to perceptors with a configurable amount of rolling short-term memory, which may allow a limited amount of prior inputs to be accessed in addition to the most-recent input.

A worldview predictor module: A generative AI component that has been trained to predict what will happen next according to the specific worldview embodied in the specialized training data set. The worldview predictor module may produce an arbitrary number of predictions based at least in part on the current perceived reality of computer system 1100 and may emit them on to the connectome data bus along with information about the likelihood of each prediction. The prediction outputs of this component may be loosely compared to thoughts or ideas.

A worldview prediction stream bus interface: A software component that provides decoupling of the raw worldview prediction stream data bus from the connectome data bus for purposes of architectural isolation, data volume management, and/or data filtration.

A worldview prediction stream data bus: A data pathway capable of carrying the worldview predictions emitted by the worldview predictor module to any number of worldview prediction stream bus interface instances over any suitable data network to allow for flexibility in the location and layout of self-navigating AI systems.

An observer module: An encapsulated software component that monitors the activity of computer system 1100 via the connectome data bus and emits commands for the purposes of correcting, improving, recovering, and/or regulating computer system 1100. The Observer Module may be loosely regarded as a specialized type of perceptor that is perceiving the internal data flow of computer system 1100.

A reality convergence module: An encapsulated software component that determines the current perceived reality of computer system 1100 by evaluating the predictions emitted by the worldview predictor module against the outputs of the perceptors. The reality convergence module may use system state information to assist in the determination of perceived reality, such as a general perception suppression command emitted by the observer module because of very low lighting conditions. A short-term memory archive of reality convergence decisions and the associated navigational branching (the ensuing predictions made from decisions) may be held in the reality convergence module for situations in which the initial executed path of action does not produce the desired outcome. This module may be capable of providing metrics about the process and result of reality convergence including the disjointed reality score of each individual thought or prediction. Note that the reality convergence module may be split into multiple components. The reality convergence module and an executive function module may be used to navigate toward goals and to improve navigational efficacy through experience.

An awareness output stream bus interface: A software component that provides decoupling of the connectome data bus from any subsystems or connected peer systems and that allows for data formatting, filtering, and/or velocity control.

An awareness output stream data bus: A data pathway capable of carrying the outputs emitted by the self-navigating AI system to any number of awareness output router instances over a suitable data network to allow for flexibility in the functionality, location, and/or layout of self-navigating AI systems.

An awareness output router: A data routing component that directs the outputs of the self-navigating AI system to the appropriate recipient subsystems, peer systems, and/or user interfaces. This component may be roughly viewed as the outbound connection from the brain to the spinal column. As an example, the observer module may emit a command to adjust a camera position because of solar glare. The awareness output router may direct this environmental awareness response to the motion control sub-system, where the programmed camera position adjustment routine may be performed.

Note that perceptor components may include:

An input adjuster: A software sub-component that transforms input data when necessary in order to comply with the AI model processor input interfacing specifications. Common transformations may include: image resizing and/or changing image color mode.

An influencer: A software sub-component that alters the input data according to the influencing interface (intentional biasing) specifications of the AI Model processor. The Influencer may receive influencing instructions from a learned association interface module that is connected to the perceptor in which it operates.

An AI model processor: A software sub-component that encapsulates an AI model along with the supporting code needed to produce well-formed inference output. This sub-component may require access to AI accelerator hardware, such as a GPU.

An output manager: A software sub-component that applies a configured final transformation or filtration processing operation(s) to the output of the AI model processor and that sends the output to the learned association interface module connected to the perceptor in which it operates.

Learned association interface module components.

A connectome data bus connector: A data bus client software sub-component that establishes and maintains a connection to the connectome data bus and that performs the data message sending and receiving function on behalf of the other learned association interface module sub-components.

A configuration manager: A software sub-component that provides one or more interfaces for accepting and validating configuration information related to the learned association interface module.

An influencing processor: A software sub-component that evaluates the augmentation and suppression influences associated with the data messages received via the connectome data bus and that produces an assessment of the influences in the form of influencing instructions related to the specific perceptor for which it is configured.

A perceptor connector: A software sub-component that connects to a perceptor instance as configured by the configuration manager sub-component and that performs the data message sending and receiving function between the perceptor and the learned association interface module in which it operates.

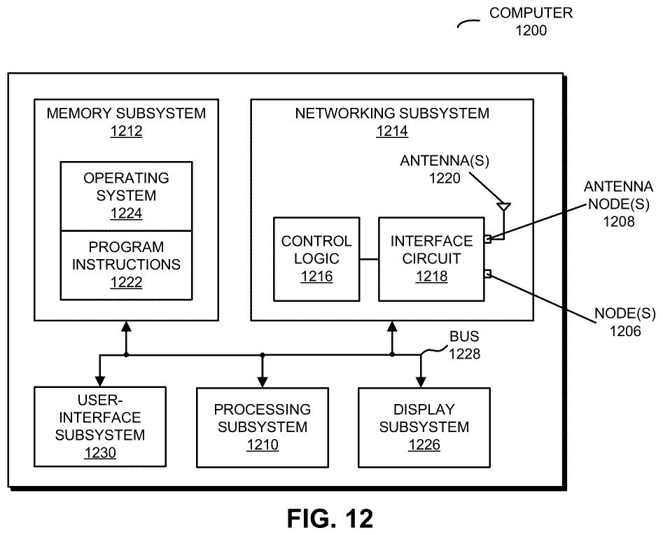

We now describe embodiments of a computer, which may perform at least some of the operations in the machine-learning techniques. FIG. 12 presents a block diagram illustrating an example of a computer 1200, e.g., in a computer system (such as computer system 200 in FIG. 2 or computer system 1100 in FIG. 11), in accordance with some embodiments. For example, computer 1200 may include: one of computers 210. This computer may include processing subsystem 1210, memory subsystem 1212, and networking subsystem 1214. Processing subsystem 1210 includes one or more devices configured to perform computational operations. For example, processing subsystem 1210 can include one or more microprocessors, ASICs, microcontrollers, programmable-logic devices, GPUs and/or one or more DSPs. Note that a given component in processing subsystem 1210 are sometimes referred to as a ‘computation device’.

Memory subsystem 1212 includes one or more devices for storing data and/or instructions for processing subsystem 1210 and networking subsystem 1214. For example, memory subsystem 1212 can include dynamic random access memory (DRAM), static random access memory (SRAM), and/or other types of memory. In some embodiments, instructions for processing subsystem 1210 in memory subsystem 1212 include: program instructions or sets of instructions (such as program instructions 1222 or operating system 1224), which may be executed by processing subsystem 1210. Note that the one or more computer programs or program instructions may constitute a computer-program mechanism. Moreover, instructions in the various program instructions in memory subsystem 1212 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1210.

In addition, memory subsystem 1212 can include mechanisms for controlling access to the memory. In some embodiments, memory subsystem 1212 includes a memory hierarchy that comprises one or more caches coupled to a memory in computer 1200. In some of these embodiments, one or more of the caches is located in processing subsystem 1210.

In some embodiments, memory subsystem 1212 is coupled to one or more high-capacity mass-storage devices (not shown). For example, memory subsystem 1212 can be coupled to a magnetic or optical drive, a solid-state drive, or another type of mass-storage device. In these embodiments, memory subsystem 1212 can be used by computer 1200 as fast-access storage for often-used data, while the mass-storage device is used to store less frequently used data.

Networking subsystem 1214 includes one or more devices configured to couple to and communicate on a wired and/or wireless network (i.e., to perform network operations), including: control logic 1216, an interface circuit 1218 and one or more antennas 1220 (or antenna elements). (While FIG. 12 includes one or more antennas 1220, in some embodiments computer 1200 includes one or more nodes, such as antenna nodes 1208, e.g., a metal pad or a connector, which can be coupled to the one or more antennas 1220, or nodes 1206, which can be coupled to a wired or optical connection or link. Thus, computer 1200 may or may not include the one or more antennas 1220. Note that the one or more nodes 1206 and/or antenna nodes 1208 may constitute input(s) to and/or output(s) from computer 1200.) For example, networking subsystem 1214 can include a Bluetooth™ networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi® networking system), an Ethernet networking system, and/or another networking system.

Networking subsystem 1214 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, computer 1200 may use the mechanisms in networking subsystem 1214 for performing simple wireless communication between electronic devices, e.g., transmitting advertising or beacon frames and/or scanning for advertising frames transmitted by other electronic devices.

Within computer 1200, processing subsystem 1210, memory subsystem 1212, and networking subsystem 1214 are coupled together using bus 1228. Bus 1228 may include an electrical, optical, and/or electro-optical connection that the subsystems can use to communicate commands and data among one another. Although only one bus 1228 is shown for clarity, different embodiments can include a different number or configuration of electrical, optical, and/or electro-optical connections among the subsystems.

In some embodiments, computer 1200 includes a display subsystem 1226 for displaying information on a display, which may include a display driver and the display, such as a liquid-crystal display, a multi-touch touchscreen, etc. Moreover, computer 1200 may include a user-interface subsystem 1230, such as: a mouse, a keyboard, a trackpad, a stylus, a voice-recognition interface, and/or another human-machine interface.

Computer 1200 can be (or can be included in) any electronic device with at least one network interface. For example, computer 1200 can be (or can be included in): a desktop computer, a laptop computer, a subnotebook/netbook, a server, a supercomputer, a tablet computer, a smartphone, a cellular telephone, a consumer-electronic device, a portable computing device, communication equipment, and/or another electronic device.

Although specific components are used to describe computer 1200, in alternative embodiments, different components and/or subsystems may be present in computer 1200. For example, computer 1200 may include one or more additional processing subsystems, memory subsystems, networking subsystems, and/or display subsystems. Additionally, one or more of the subsystems may not be present in computer 1200. Moreover, in some embodiments, computer 1200 may include one or more additional subsystems that are not shown in FIG. 12. Also, although separate subsystems are shown in FIG. 12, in some embodiments some or all of a given subsystem or component can be integrated into one or more of the other subsystems or component(s) in computer 1200. For example, in some embodiments program instructions 1222 are included in operating system 1224 and/or control logic 1216 is included in interface circuit 1218.

Moreover, the circuits and components in computer 1200 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 1214 and/or computer 1200. The integrated circuit may include hardware and/or software mechanisms that are used for transmitting signals from computer 1200 and receiving signals at computer 1200 from other electronic devices. Aside from the mechanisms herein described, radios are generally known in the art and hence are not described in detail. In general, networking subsystem 1214 and/or the integrated circuit may include one or more radios.

In some embodiments, an output of a process for designing the integrated circuit, or a portion of the integrated circuit, which includes one or more of the circuits described herein may be a computer-readable medium such as, for example, a magnetic tape or an optical or magnetic disk or solid state disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the machine-learning techniques may be implemented using program instructions 1222, operating system 1224 (such as a driver for interface circuit 1218) or in firmware in interface circuit 1218. Thus, the machine-learning techniques may be implemented at runtime of program instructions 1222. Alternatively or additionally, at least some of the operations in the machine-learning techniques may be implemented in a physical layer, such as hardware in interface circuit 1218.

In the preceding description, we refer to ‘some embodiments’. Note that ‘some embodiments’ describes a subset of all of the possible embodiments, but does not always specify the same subset of embodiments. Moreover, note that the numerical values provided are intended as illustrations of the machine-learning techniques. In other embodiments, the numerical values can be modified or changed.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer system, comprising:
a computation device;
memory configured to store program instructions, wherein, when executed by the computation device, the program instructions cause the computer system to perform one or more operations comprising:
receiving a sequence of sensory inputs associated with an object in an environment, wherein the sequence of sensory inputs occurs at different timestamps;
training a predictive model that predicts a future location of at least a representation corresponding to the object in the environment based at least in part on the sequence of sensory inputs; and
providing a world view of the object in the environment based at least in part on the pretrained predictive model, wherein the providing of the world view comprises:
comparing the predicted future location of at least the representation with the future location of the object in the environment; and
when a difference between the predicted future location of at least the representation and the future location of the object in the environment exceeds a predefined value, selectively performing a remedial action.

2. The computer system of claim 1, wherein the sequence of sensory inputs comprise images.

3. The computer system of claim 1, wherein the representation comprises a three-dimensional (3D) bounding box surrounding the object.

4. The computer system of claim 3, wherein the representation comprises a geometric object specified by at least four vertices.

5. The computer system of claim 4, wherein the geometric object is specified by an orientation.

6. The computer system of claim 4, wherein the geometric object is specified by metadata comprising one or more labels for the object or one or more classifications of the object.

7. The computer system of claim 1, wherein the predictive model is generated using a generative neural network transformer.

8. The computer system of claim 1, wherein the operations comprise operating, based at least in part on the pretrained predictive model and relative to operation without the pretrained predictive model, an electronic device configured to acquire the sensory inputs at one or more of: at reduced power consumption, a reduced acquisition rate of the sensory inputs, a reduced latency of the sensory inputs, an increased accuracy of the sensory inputs, or identification of motion of the object even when a classification of the object is unknown.

9. The computer system of claim 1, wherein the operations comprise reducing, based at least in part on the pretrained predictive model and relative to operation without the pretrained predictive model, a size of a training dataset used to train the pretrained predictive model.

10. The computer system of claim 1, wherein the operations comprise storing, in memory, the pretrained predictive model.

11. The computer system of claim 1, wherein the remedial action comprises switching from the pretrained predictive model to a second pretrained predictive model, and the second pretrained predictive model more accurately predicts the future location of the object than the pretrained predictive model.

12. The computer system of claim 11, wherein the operations comprise concurrently executing the pretrained predictive model and the second pretrained predictive model.

13. The computer system of claim 11, wherein the remedial action comprises augmenting or suppressing the second pretrained predictive model based at least in part on the difference.

14. The computer system of claim 1, wherein the remedial action comprises concurrently executing multiple pretrained predictive models based at least in part on the difference and the multiple pretrained predictive models are different from the pretrained predictive model.

15. The computer system of claim 1, wherein the sensory information comprises multiple different perspectives of the object.

16. The computer system of claim 1, wherein the operations comprise providing learning addressed to a second computer system or receiving second learning associated with the second computer system, and the learning or the second learning comprises information associated with the pretrained predictive model or a second pretrained predictive model.

17. The computer system of claim 1, wherein the remedial action comprises: changing values of weights in the pretrained predictive model, augmenting at least a portion of the pretrained predictive model, or suppressing at least a second portion of the pretrained predictive model.

18. The computer system of claim 1, wherein the operations comprise providing the world view to a pretrained neural network.

19. A non-transitory computer-readable storage medium for use in conjunction with a computer system, the computer-readable storage medium configured to store program instructions that, when executed by the computer system, causes the computer system to perform operations comprising:
receiving a sequence of sensory inputs associated with an object in an environment, wherein the sequence of sensory inputs occurs at different timestamps;
training a predictive model that predicts a future location of at least a representation corresponding to the object in the environment based at least in part on the sequence of sensory inputs; and
providing a world view of the object in the environment based at least in part on the pretrained predictive model, wherein the providing of the world view comprises:
comparing the predicted future location of at least the representation with the future location of the object in the environment; and
when a difference between the predicted future location of at least the representation and the future location of the object in the environment exceeds a predefined value, selectively performing a remedial action.

20. A method for providing a world view of an object in an environment, comprising:
by a computer system:
receiving a sequence of sensory inputs associated with the object in the environment, wherein the sequence of sensory inputs occurs at different timestamps;
training a predictive model that predicts a future location of at least a representation corresponding to the object in the environment based at least in part on the sequence of sensory inputs; and
providing the world view of the object in the environment based at least in part on the pretrained predictive model, wherein the providing of the world view comprises:
comparing the predicted future location of at least the representation with the future location of the object in the environment; and
when a difference between the predicted future location of at least the representation and the future location of the object in the environment exceeds a predefined value, selectively performing a remedial action.
